(19) United States
(12) Patent Application Publication
(10) Pub. No.: US 2010/0060006 A1
(43) Pub. Date: Mar. 11, 2010

(54) GENERATOR

(76) Inventors: Hironobu Ichimaru, Fukuoka (JP); Naofumi Yoshimi, Fukuoka (JP)

Correspondence Address: DICKSTEIN SHAPIRO LLP, 1825 EYE STREET NW, Washington, DC, 20006-5403, US

(21) Appl. No.: 12/514,660

(22) PCT Filed: Sep. 14, 2007
(86) PCT No.: PCT/JP2007/067931

§ 371 Date: May 13, 2009

(30) Foreign Application Priority Data
Nov. 14, 2006 (JP) 2006-307568

(51) Int. Cl. H02K 7/18; H02K 5/12

(52) U.S. Cl. 290/52; 310/85

(57) ABSTRACT

The generator has a driving section provided with an impeller received in a casing, which is formed so as to allow the fluid at high-temperature and under high-pressure to flow in an inlet and to allow the fluid to flow out of an outlet, and adapted to rotate the impeller by the flow pressure of fluid, a power generating section consisting of a rotor and a stator coil, and a driving shaft having one end for fixing the impeller and the other end for fixing the rotor. Electric power is generated at the power generating section by rotating the rotor by the impeller through the driving shaft. The generator is further provided with a partition wall for hermetically partitioning the rotor and the stator coil with the rotor contained in a rotor containing chamber formed therein.

### TECHNICAL FIELD

The invention relates to a generator which is disposed in a pipe system for transferring fluid at high temperature and under high pressure (vapors, gas, liquid, and a combination thereof), in particular, a special generating apparatus capable of preferably being used at high temperature and under high pressure.

### BACKGROUND ART

Conventionally, as a typical generator, JP-H9-65628 discloses a generator including an impeller which rotates with the fluid, a rotating shaft which rotates integrally with the impeller, a rotor fixed to the rotating shaft, and a stator coil which is adapted to be disposed for surrounding the rotor, wherein electric power is generated by rotating the rotor.

By the way, as represented by a tire vulcanizer, if the generator is disposed in a heating apparatus which uses, for example, hot water or high-temperature steam or a fluid at high-temperature and under high-pressure, such as high-temperature gas, it is necessary to avoid negative influences on a stator coil caused by the fluid at high-temperature and under high-pressure. However, in the prior art generator, there is no disclosure of a generator including a construction for protecting the stator coil against the fluid at high-temperature and under high-pressure.

Further, as a fluid sending-out device, JP-2006-22644-A discloses a device comprising an electric motor in which a rotor and stator coil are hermetically partitioned by means of a partitioning wall or a can, wherein the apparatus is adapted to allow the fluid to flow in an inlet and to allow the fluid to flow out of an outlet.

Although the fluid sending-out device is adapted to hermetically partition the stator coil by a partitioning wall, the stator coil is insulated from the fluid so as to allow the fluid sending-out device to avoid negative influences caused by the fluid at high-temperature and under high-pressure, this fluid sending-out device is persistently a device in which the impeller is rotated by the electric motor so as to send out the fluid, which is essentially different from the generator according to the present invention.

Further, in a generator of which a rotor is subjected to an environment at high-temperature and under high-pressure, the outer surface of the rotor can become corroded (rust), or iron dust and the like due to rusting becomes adhered to the outer surface of the rotor.

As a result, there arises a problem that a product life of the rotor is shortened and the rotation of the rotor is locked due to the adhered dust.

### DISCLOSURE OF INVENTION

The present invention is made in order to solve the prior art problem as described above and thus the object of the present invention is to provide a generator in which the stator coil thereof can be protected from the fluid at high-temperature and under high-pressure, and in the case of contaminants such as the iron dust and the like due to rust being adhered to the outer surface of the rotor, such contaminants can be eliminated.

### Means for Solving the Problem

In order to overcome the problems, the generator according to one aspect of the present invention comprises,

a driving section provided with an impeller received in a casing, which is formed so as to allow fluid at high-temperature and under high-pressure to flow in an inlet and to allow the fluid to flow out of an outlet, and adapted to rotate the impeller by the flow pressure of the fluid,

a power generating section consisting of a rotor and a stator coil,

a driving shaft having one end for fixing the impeller and the other end for fixing the rotor,

a partitioning wall for hermetically partitioning the rotor and stator with the rotor contained in a rotor containing chamber formed therein,

a dust discharging passage which extends from the rotor containing chamber to the inside of the casing, and

a dust sending-out device for sending-out dust adhered to the rotor toward the dust discharging device,

wherein electric power is generated at the power generating section by rotating the rotor by the impeller through the driving shaft, and

wherein the dust sending-out device is a tank communicating with the rotor containing chamber, the tank being adapted to send out the dust toward the dust discharging device by releasing the pressure hydraulically regenerated through the dust discharging device into the tank together with the driving operation of a driving portion, together with the stopping operation of the driving portion.

Further, the generator according to another aspect of the invention comprises,

a driving section provided with an impeller received in a casing, which is formed so as to allow the fluid at high-temperature and under high-pressure to flow in an inlet and to allow the same to flow out of an outlet, and adapted to rotate the impeller by the flow pressure of the fluid,

a power generating section consisting of a rotor and a stator coil,

a driving shaft having one end for fixing the impeller and the other end for fixing the rotor,

a partitioning wall for hermetically partitioning the rotor and the stator coil with the rotor contained in a rotor containing chamber formed therein,

a dust discharging device extending from the rotor containing chamber to inside of the casing,

a dust sending out device which sends out the dust adhered to the rotor toward the dust discharging device,

wherein electric power is generated at the power generating section by rotating the rotor by the impeller through the driving shaft, and

wherein the dust sending-out device is a fluid supplying device communicating with the rotor containing chamber, the dust being sent out toward the dust discharging passage by forcibly supplying the same fluid as that which flows in the driving portion with the rotor containing chamber, in a state that the driving portion is stopped.

Further, the generator according to another aspect of the invention is such that the corrosion resistant surface treatment or a mold-release surface treatment, or the corrosion resistant and mold-release surface treatment is (are) made on the outer surface of the rotor.

### EFFECTS OF THE INVENTION

The generator according to one aspect of the present invention comprises a partition wall for hermetically partitioning the rotor and the stator coil and, due to the partition wall, the stator coil is insulated from the fluid at high-temperature and under high-pressure. Thereby, the stator coil is not subjected to negative influences of the fluid at high-temperature and under high-pressure to thereby avoid any problems caused by the influences by the fluid.

The generator according to another aspect of the present invention is such that the corrosion resistant surface treatment or a mold-release surface treatment, or the corrosion resistant and mold-release surface treatment is (are) made on the outer surface of the rotor. The corrosion resistant surface treatment in this case includes all of the corrosion resistant surface treatments such as metal spraying, galvanizing treatment, fluoroethylene resin (Teflon (registered trademark)) baking treatment, electrodeposition coating and the other 15 heat-resistant coating which is recognized to have the corrosion resistant property (rust-resisting property) against the corrosion occurring by a heating medium (for example, vapors or nitrogen gas). In this way, since the corrosion resistant surface treatment is performed on the outer surface of the rotor, the rotor cannot be corroded and the rust occurring and the like can be prevented, so that any problems caused by contaminants such as the iron dust and the like due to the rust occurring on the outer surface of the rotor can be prevented. Further, the mold-release surface treatment is a surface treatment that makes it difficult for contaminants and the like to adhere and, if adhered, they are easy to remove. Furthermore, the corrosion resistant and mold-release surface treatment are surface treatments providing both the corrosion resistant property and mold-release property.

The generator according to another aspect of the present invention is characterized by a construction which comprises the dust discharging passage extending from the rotor containing chamber to the inside of the casing and the dust sending-out device which sends out the dust adhered to the rotor toward the dust discharging passage. Thus, the dust adhered to the outer surface of the rotor is sent out toward the dust discharging passage by means of the dust sending-out device and is discharged from the dust discharging passage into the fluid in the casing. In this way, since the dust adhered to the outer surface of the rotor can be eliminated, it is possible to avoid any problems, for example, the locking of the rotation of the rotor, caused by the adhered dust.

### BRIEF DESCRIPTION OF DRAWINGS

FIG. 1 is a cross sectional view of an embodiment of a generator according to the present invention.

FIG. 2 is a schematic cross sectional view of an embodiment of a tire vulcanizer in which the generator according to the present invention is disposed.

### MODE FOR CARRYING OUT THE INVENTION

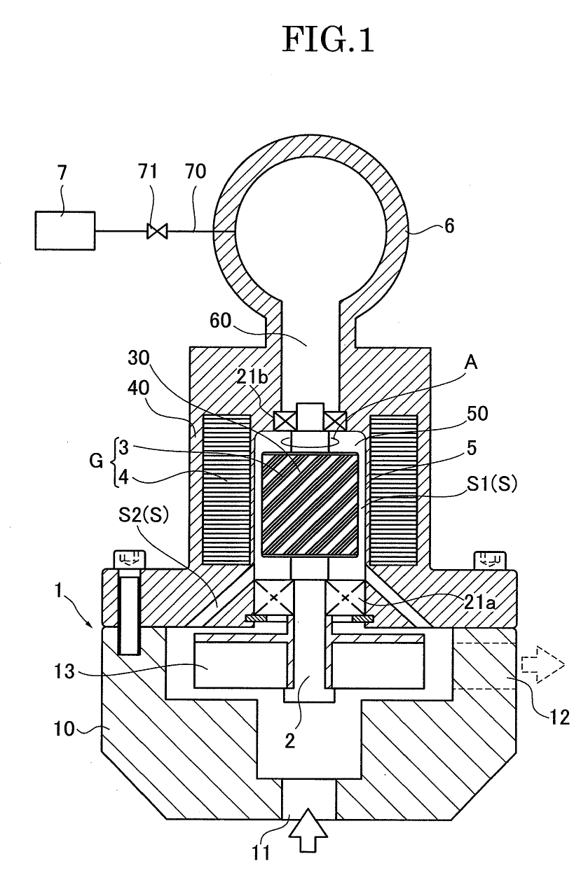

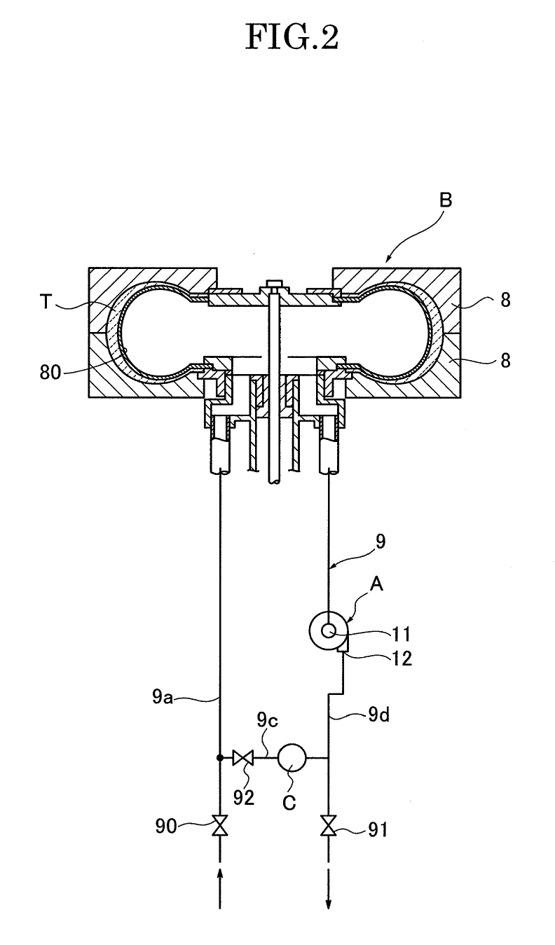

FIG. 1 is a cross sectional view of an embodiment of a generator according to the present invention. FIG. 2 is a schematic cross sectional view of an embodiment of a tire vulcanizer in which the generator in FIG. 1 is disposed.

As shown in FIG. 2, the tire vulcanizer B includes; upper and lower die halves 8, 8; a bladder 80 which will be expanded and reduced by supplying and discharging heating fluid (vapors); whereby the raw tire T is vulcanizedly formed while holding the same by pressing the bladder 80 expanded by supplying the fluid (vapors) at high-temperature and under high-pressure onto an inner surface of the raw tire T which is set inside the die halves 8, 8.

Connected to the bladder 80 is a pipe system for transferring the fluid. In this case; connected inside the bladder 80 is a fluid supplying pipe 9a 25 provided with a stop valve 90, and a fluid discharging pipe 9b provided with a stop valve 91. The fluid supplying pipe 9a and fluid discharging pipe 9b are connected via a communicating pipe 9c in a position which is closer to the bladder 80 than that of the stop valves 90, 91. And in this case, the communicating pipe 9c, the fluid supplying pipe 9a, the fluid discharging pipe 9b, and an inside surface of the bladder 80 form a circulating closed loop circuit 9 and on which a fluid sending-out device C is disposed. In this embodiment, although the fluid sending-out device C is disposed at a position of the communicating pipe 9c on its way to the fluid discharging pipe 9b, it may be disposed at a position of the fluid discharging pipe 9b on its way toward the stop valve 91 or it may be disposed at a position of the fluid supplying pipe 9a on its way from the stop valve 90. In addition, also provided on the communicating pipe 92 is a stop valve 92.

Thus, in the state that the raw tire T is set inside the die halves 8, 8, when the stop valves 90, 91 are released and then the fluid (vapors) at high-temperature and under high-pressure is supplied from the fluid supplying pipe 9a, the fluid enters inside the bladder 80 and the stop valves 90, 91 are closed when the inside of the bladder 80 is filled with the fluid.

As described above, after the inside of the bladder 80 is filled with the fluid, the circulating closed circuit 9 is opened by releasing the stop valve 92 of the communicating pipe 9c. In this state, the fluid sending-out device C is operated to circulate the fluid in the circulating closed circuit 9. This circulation of the fluid can maintain a uniform temperature within the bladder 80.

As described above, the raw tire T is vulcanizedly formed while 25 circulating the fluid in the circulating closed circuit 9. After the vulcanized forming is completed, the stop valves 91, 92 are opened and the stop valve 90 is closed thereby operating the fluid sending-out device C. The fluid filled inside the bladder 80 can be quickly discharged from the fluid discharging pipe 9b.

And in this embodiment, a generator A is disposed within the fluid discharging pipe 9b in said pipe system. The construction of the generator A will be explained with reference to FIG. 1.

As shown in FIGS. 1 and 2, a reference numeral 1 shows a driving portion, where an inlet 11 connected to an upstream side of the fluid discharging pipe 9b is formed in a central portion of a casing 10 and an outlet 12 connected to a downstream side of the fluid discharging pipe 9b is formed in the periphery thereof. Provided inside the casing 10 is the impeller 13. And, the generator is so constructed that the impeller 13 is adapted to rotate by the flow pressure of the fluid (vapors) at high temperature and under high-pressure which enters the inlet 11 and flows out the outlet 12.

The impeller 13 is attached to a lower end of a driving shaft 2. A rotor 3 is attached to an upper end of the driving shaft 2. The driving shaft 2 is supported by bearings 21a, 21b.

The rotor 3 is paired with a stator coil 4 provided around the rotor 3 so as to form a generating portion G to thereby generate electricity by rotating the rotor 3. Further, in this embodiment, the electricity generated by the generating portion G is used as an auxiliary power supply of the tire vulcanizer B. In addition, the stator coil 4 is covered with a cover 40 for the stator coil 4.

The stator 3 is hermetically partitioned by a partitioning wall (can) 5 from the stator coil 4. Inside the partitioning wall 5 there is formed a rotor containing chamber 50 for containing the rotor 3 therein.

As described above, since the generator includes a partitioning wall 5 which hermetically partitions the rotor 3 from the stator coil 4, thus the stator coil 4 is insulated from the fluid at high-temperature and under high pressure by means of the partitioning wall 5. The stator coil 4 is thereby prevented from being subjected to negative influences by the fluid and thus can avoid any problems caused by negative influences of the fluid.

Further, the rotor 3 is made of a silicon steel plate, an iron plate, and a composite material of the silicon steel plate and aluminum plate and the like. In addition, the partitioning wall 5 is made of a nonmagnetic substance (titanium, stainless steel, plastic, aluminum, ceramic and the like, or composites including any of these nonmagnetic materials) or a feebly-magnetic substance (titanium, stainless steel, plastic, aluminum, ceramic and the like, or composites including any of these nonmagnetic materials).

And, there is formed a gap (Si) between the inner surface of the rotor containing chamber 50 and the outer surface of the rotor 3. The gap (S1) communicates with the inside of the casing 10 via a communicating hole (S2) formed through a radial and wall direction thickness of the upper part of the casing 10. Accordingly, the gap (S1) communicates in sequence with the communicating hole (52) to form a dust discharging passage (5) into the inside of the casing 10.

The corrosion resistant surface treatment is performed on the outer surface of the rotor 3 by spraying aluminum. The corrosion resistant surface treatment prevents the generation of rust. Further, the mold-release surface treatment, or the corrosion resistant and mold-release surface treatment is (are) performed on the outer surface of the rotor 3.

Alternatively, the outer surface of the rotor 3 may be formed with slanting grooves 30 as the dust sending-out device which sends out the dust adhered to its outer circumferential surface thereof toward the dust discharging passage (S). The slanting grooves 30 are formed to send out the dust toward the dust discharging passage (S) (downward) with upper ends thereof being directed toward the direction of rotation A of the driving shaft 2, and thus the entire grooves are forwardly inclined by means of a centrifugal force occurring by the rotation of the rotor 3 and a component force thereof along the axial direction. Thus, by employing the slanting grooves 30, it is possible to form the dust discharging device 30 by simply forming these grooves on the outer surface of the rotor 3, which can simplify the construction and reduce the cost.

Alternatively, in an embodiment, in addition to the slanting grooves 30, the dust discharging device further comprises a tank 6 and a fluid supplying device 7.

The tank 6 communicates with the rotor containing chamber 50 via a communicating passage 60 by connecting to an upper end of the rotor containing chamber 50. Thus, if the driving portion 1 operates, a portion of the fluid in the casing 10 reversibly flows out of the dust discharging device (S) (communicating hole (S2) to gap (S1)) and is hydraulically regenerated into the tank 6. And if the driving portion 1 stops together with the stoppage of work, by the force of which the dust adhered to the rotor 3 is sent out toward the dust discharging passage (S) via the dust discharging passage into the fluid inside the casing 10 (gap (S1) to the communicating hole (S2)).

The fluid supplying device 7 is a device in order for forcibly supplying the fluid into the rotor containing chamber 50. In this embodiment, the fluid supplying device 7 is connected to an upper end of the tank 6 via a supplying pipe 70. A supplying pipe 70 is provided with a stop valve 71 on its way to the fluid supplying device 7. Accordingly, in a state that the driving portion 1 stops, if the stop valve 71 is released, the fluid is forcibly supplied from the fluid supplying device 7 via the supplying pipe 70 and the tank 6 into the rotor containing chamber 50. By means of the force, the dust adhered to the rotor 3 can be sent out toward the dust discharging passage.

Further, in a case of employing the fluid supplying device 7, the supplying pipe 70 may be directly connected to the inside of the rotor containing chamber 50, without attaching the tank 6 thereto. Further, the fluid with which the fluid supplying device 7 is supplied is preferably the same fluid as that which flows in the driving portion 1, so that mixing of different fluids can be avoided and taken in the fluid for supplying from the pipe system.

In the embodiment described above, although the slanting grooves 30, the tank 6, and the fluid supplying device 7 or three devices are combined together as the dust sending-out device, only one device among the above three 20 devices may also be used, or two or more among them may also be used.

Furthermore, the generator according to the present invention is not necessarily disposed on the pipe system to the bladder in the tire vulcanizer as described above but, in the various industries, may be disposed on the pipe system for transferring the fluid at high temperature and under high. pressure.

1. A generator comprising,
a drive section provided with an impeller received in a casing, which is formed so as to allow the fluid at high-temperature and under high-pressure to flow in an inlet and to allow the fluid to flow out of an outlet, and adapted to rotate the impeller by the flow pressure of fluid,
a power generating section consisting of a rotor and a stator coil,
a driving shaft having one end for fixing the impeller and the other end for fixing the rotor,
wherein electric power is generated at the power generating section by rotating the rotor by the impeller through the driving shaft, and
wherein the generator further comprises a partition wall for hermetically partitioning the rotor and the stator coil with the rotor contained in a rotor containing chamber formed therein.

2. A generator comprising,
a driving section provided with an impeller received in a casing, which is formed so as to allow the fluid at high temperature and under high-pressure to flow in an inlet and to allow the same to flow out of an outlet, and adapted to rotate the impeller by the flow pressure of the fluid,
a power generating section consisting of a rotor and a stator coil,
a driving shaft having one end for fixing the impeller and the other end for fixing the rotor,
a partitioning wall for hermetically partitioning the rotor and the stator coil with the rotor contained in a rotor containing chamber formed therein,
a dust discharging device extending from the rotor containing chamber to inside of the casing, and
a dust sending-out device which sends out the dust adhered to the rotor toward the dust discharging device,
wherein electric power is generated at the power generating section by rotating the rotor by the impeller through the driving shaft, and
wherein the dust sending-out device is a fluid supplying device communicating with the rotor containing chamber, the dust being sent out toward the dust discharging passage by forcibly supplying the same fluid as that which flows in the driving portion with the rotor containing chamber, in a state that the driving portion is stop.

3. The generator of claim 1, wherein the corrosion resistant surface treatment or mold-release surface treatment, or the corrosion-resistant and mold-release surface treatment is (are) made on an outer surface of the rotor.

4. The generator of claim 2 wherein the corrosion resistant surface treatment or mold-release surface treatment, or the corrosion-resistant and mold-release surface treatment is (are) made on an outer surface of the rotor.

5. (canceled)

6. (canceled)

7. (canceled)

8. (canceled)
